(19) United States
(12) Patent Application Publication
(10) Pub. No.: US 2025/0370151 A1
(43) Pub. Date: Dec. 4, 2025

(54) METHODS FOR GENERATING A PERMEABILITY MODEL FOR A SUBSURFACE

(71) Applicant: Schlumberger Technology Corporation, Sugar Land, TX (US)

(72) Inventors: Mohamed Nabeel Saif, Dhahran (SA); Abhinav Chawla, Gurgaon (IN)

(21) Appl. No.: 19/220,960

(22) Filed: May 28, 2025

(30) Foreign Application Priority Data
May 29, 2024 (IN) 202411041700

(51) Int. Cl. G01V 1/28

(52) U.S. Cl. CPC G01V 1/282; G01V 2210/6246; G01V 2210/646; G01V 2210/665

(57) ABSTRACT

A method for generating a single-upscaled permeability model for a subsurface is disclosed. The method includes receiving input data including field-derived discrete fracture network (DFN) data and a subsurface model. The method also includes generating a synthetic driver-based DFN based upon the field-derived DFN data. The method further includes generating the single-upscaled permeability model using the subsurface model and the synthetic driver-based DFN.

### CROSS-REFERENCE TO RELATED APPLICATIONS

This application claims priority to Indian Provisional Patent Application No. 202411041700 filed on May 29, 2024, which is incorporated by reference to the extent consistent with the present disclosure.

### BACKGROUND

In the oil and gas industry, understanding and accurately representing the behavior of natural fractures of a subsurface, such as within rock masses, is beneficial for predicting fluid flow, mechanical response, and overall system performance. Discrete Fracture Network (DFN) modeling has emerged as a fundamental tool for simulating the spatial distribution and properties of fractures within the subsurface formations, and are conventionally applied in the development of hydrocarbon reservoirs, geothermal energy extraction, or the like. A challenge in DEN modeling, however, is the accurate scaling of fracture properties from core-scale or outcrop observations to field-scale models. Fracture attributes or properties, such as aperture, length, orientation, and connectivity, are inherently heterogeneous and may often exhibit complex spatial correlations. Accordingly, characterizing, parameterizing, and upscaling the fracture attributes for large-scale models has proven to be computationally intensive and time-consuming. Further, conventional upscaling techniques often rely on simplifying assumptions or empirical relationships that may not adequately capture the behavior of fracture networks.

What is needed, then, are improved methods for generating upscaled permeability models for a subsurface.

### SUMMARY

A method for generating a single-upscaled permeability model for a subsurface is disclosed. The method includes receiving input data including field-derived discrete fracture network (DFN) data and a subsurface model. The method also includes generating a synthetic driver-based DFN based upon the field-derived DFN data. The method further includes generating the single-upscaled permeability model using the subsurface model and the synthetic driver-based DFN.

A computing system is also disclosed. The computing system includes one or more processors and a memory system. The memory system includes one or more non-transitory computer-readable media storing instructions that, when executed by at least one of the one or more processors, cause the computing system to perform operations. Thee operations include receiving input data. The input data includes field-derived discrete fracture network (DFN) data, a subsurface model, or any combination thereof. The subsurface model includes a multidimensional domain including a plurality of cells. The subsurface model further includes, for each cell of the plurality of cells, fracture characterization data. The operations also include generating a synthetic driver-based DFN based upon the field-derived DFN data. The operations further include generating a single-upscaled permeability model based upon the subsurface model, the field-derived DEN data, and the synthetic driver-based DFN. Generating the single-upscaled permeability model includes upscaling the respective fracture characterization data for each cell of the plurality of cells based upon the subsurface model to produce upscaled fracture characterization data; generating a fracture aperture for each cell of the plurality of cells based upon the upscaled fracture characterization data; determining a fracture permeability, for each cell of the plurality of cells, using the respective fracture aperture thereof and the respective upscaled fracture characterization data thereof based upon a deep-learning model; and generating the single-upscaled permeability model based upon the respective fracture permeability for each cell of the plurality of cells, the field-derived DFN data, and the synthetic driver-based DFN.

A non-transitory computer-readable medium is also disclosed. The medium stores instructions that, when executed by one or more processors of a computing system, cause the computing system to perform operations. The operations include receiving input data. The input data includes field-derived discrete fracture network (DFN) data, a subsurface model, or any combination thereof. The field-derived DFN data includes a plurality of fractures. The subsurface model includes a multidimensional domain including a plurality of cells. The subsurface model further includes, for each cell of the plurality of cells, fracture characterization data, and cell properties. The operations also include generating a synthetic driver-based DFN based upon the field-derived DFN data. Generating the synthetic driver-based DFN includes generating one or more fracture clusters using the plurality of fractures based upon an unsupervised density-based machine-learning (ML) model; generating one or more synthetic fracture clusters using the one or more fracture clusters based upon an unsupervised Gaussian-based ML model; generating one or more synthetic fracture drivers using the one or more synthetic fracture clusters; and generating the synthetic driver-based DEN based upon the one or more synthetic fracture drivers. The operations further include generating a single-upscaled permeability model based upon the subsurface model, the field-derived DEN data, and the synthetic driver-based DFN. Generating the single-upscaled permeability model includes upscaling the respective fracture characterization data for each cell of the plurality of cells of the subsurface model based upon the respective cell properties thereof to produce upscaled fracture characterization data; and generating a fracture aperture for each cell of the plurality of cells based upon the upscaled fracture characterization data. Generating the single-upscaled permeability model also includes determining a fracture permeability, for each cell of the plurality of cells, using the respective fracture aperture thereof and the respective upscaled fracture characterization data thereof based upon a deep-learning model; and generating the single-upscaled permeability model based upon the respective fracture permeability for each cell of the plurality of cells, the field-derived DFN data, and the synthetic driver-based DFN.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 illustrates an example computing system, according to an embodiment.

FIG. 2 illustrates a survey operation being performed by a survey tool to measure properties of the subterranean formation, according to an embodiment.

FIG. 3A illustrates a drilling operation being performed by drilling tools suspended by a rig and advanced into subterranean formations to form a wellbore, according to an embodiment.

FIG. 3B illustrates a wireline operation being performed by a wireline tool suspended by the rig and into the wellbore of FIG. 3A, according to an embodiment.

FIG. 3C illustrates a production operation being performed by a production tool deployed from a production unit or Christmas tree and into the completed wellbore for drawing fluid from the downhole reservoirs into the surface facilities, according to an embodiment.

FIG. 4 illustrates a schematic view, partially in cross section of an oilfield having data acquisition tools positioned at various locations along an oilfield for collecting data of a subterranean formation, according to an embodiment.

FIG. 5 illustrates an oilfield for performing production operations, according to an embodiment.

FIG. 6 illustrates a side view of a marine-based survey of a subterranean subsurface, according to an embodiment.

FIG. 7 illustrates a marine electromagnetic survey system, according to an embodiment.

FIG. 8 illustrates an exemplary workflow for generating a synthetic driver-based DEN, according to an embodiment.

FIG. 9A illustrates an exemplary base model from Discrete Fracture Network (DFN) modeling, according to an embodiment.

FIG. 9B illustrates an exemplary synthetic DFN generated from the workflow of FIG. 8, according to an embodiment.

FIG. 10 illustrates an exemplary workflow including permeability prediction and uncertainty analysis, according to an embodiment.

FIG. 11 illustrates a flowchart of a method for generating a single-upscaled permeability model for a subsurface, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the present disclosure. The first object or step, and the second object or step, are both objects or steps, respectively, but they are not to be considered the same object or step.

The terminology used in the description of the present disclosure herein is for the purpose of describing particular embodiments and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute [symbol] Error! Bookmark not defined. is used, the disclosure may also be interpreted to be referring to a subset.

### Computing Systems

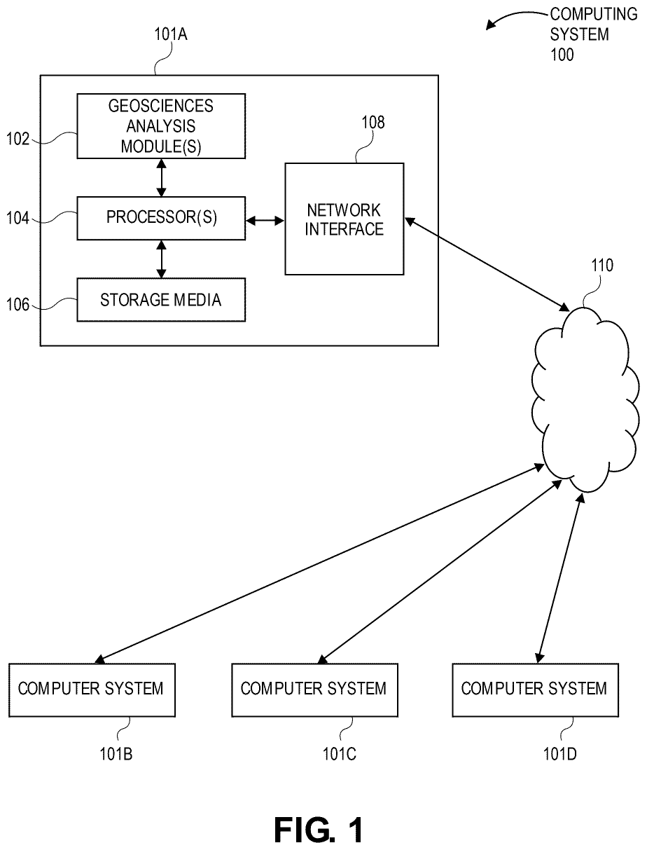

FIG. 1 depicts an example computing system 100 in accordance with some embodiments. The computing system 100 can be an individual computer system 101A or an arrangement of distributed computer systems. The computer system 101A includes one or more geosciences analysis modules 102 that are configured to perform various tasks according to some embodiments, such as one or more methods disclosed herein. To perform these various tasks, geosciences analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g., computer systems 101A and 101B may be on a ship underway on the ocean, while in communication with one or more computer systems such as 101C and/or 101D that are located in one or more data centers on shore, other ships, and/or located in varying countries on different continents). Note that data network 110 may be a private network, it may use portions of public networks, it may include remote storage and/or applications processing capabilities (e.g., cloud computing).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the example embodiment of FIG. 1 storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only [symbol] Error! Bookmark not defined. memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. Note that the instructions discussed above can be provided on one computer-readable or machine-readable storage medium, or alternatively [symbol] Error! Bookmark not defined., can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computer system 101A is one example of a computing system, and that computer system 101A may have more or fewer components than shown, may combine additional components not depicted in the example embodiment of FIG. 1, and/or computer system 101A may have a different configuration or arrangement of the components depicted in FIG. 1. The various components shown in FIG. 1 may be implemented in hardware, software, or a combination of both, hardware and software, including one or more signal processing and/or application specific integrated circuits.

It should also be appreciated that while no user input/output peripherals are illustrated with respect to computer systems 101A, 101B, 101C, and 101D, many embodiments of computing system 100 include computer systems with keyboards, mice, touch screens, displays, etc. Some computer systems in use in computing system 100 may be desktop workstations, laptops, tablet computers, smartphones, server computers, etc.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection.

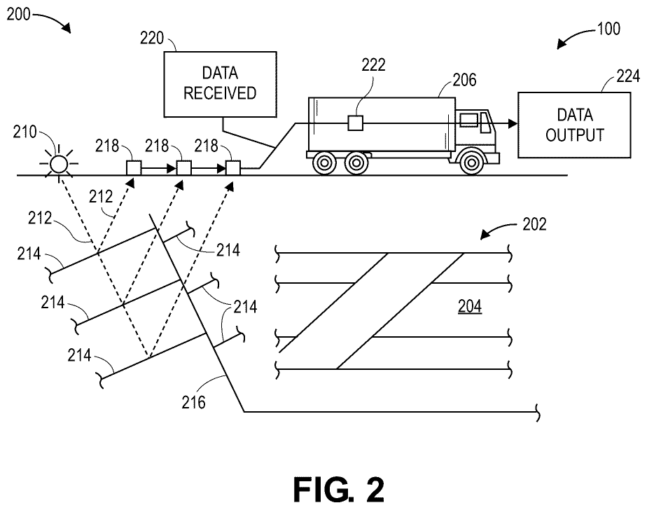

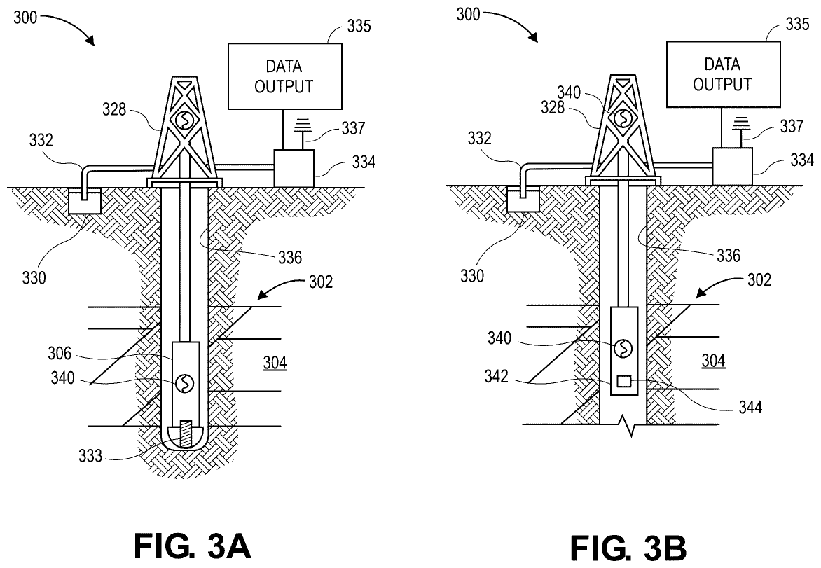

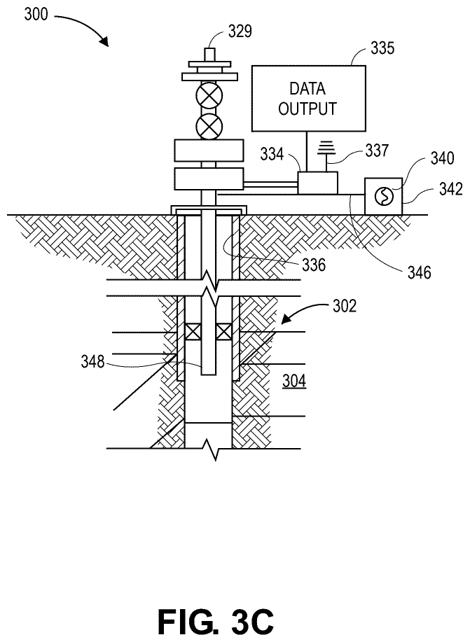

FIGS. 2 and 3A-3C generally illustrate simplified, schematic views of oilfield 200, 300 having subterranean formation 202 containing reservoir 204 therein in accordance with implementations of various technologies and techniques described herein.

FIG. 2 illustrates a survey operation being performed by a survey tool, such as seismic truck 206, to measure properties of the subterranean formation. The survey operation is a seismic survey operation for producing sound vibrations. In FIG. 2, one such sound vibration, e.g., sound vibration 212 generated by source 210, reflects off horizons 214 in earth formation 216. A set of sound vibrations is received by sensors, such as geophone-receivers 218, situated on the earth's surface. The data received 220 is provided as input data to a computer 222 of a seismic truck 206, and responsive to the input data, computer 222 generates seismic data output 224. This seismic data output may be stored, transmitted or further processed as desired, for example, by data reduction.

FIG. 3A illustrates a drilling operation being performed by drilling tools 306 suspended by rig 328 and advanced into subterranean formations 302 to form wellbore 336. Mud pit 330 is used to draw drilling mud into the drilling tools via flow line 332 for circulating drilling mud down through the drilling tools, then up wellbore 336 and back to the surface. The drilling mud is typically filtered and returned to the mud pit. A circulating system may be used for storing, controlling, or filtering the flowing drilling mud. The drilling tools are advanced into subterranean formations 302 to reach reservoir 304. Each well may target one or more reservoirs. The drilling tools are adapted for measuring downhole properties using logging while drilling tools. The logging while drilling tools may also be adapted for taking core sample 333 as shown.

Computer facilities may be positioned at various locations about the oilfield 300 (e.g., the surface unit 334) and/or at remote locations. Surface unit 334 may be used to communicate with the drilling tools and/or offsite operations, as well as with other surface or downhole sensors. Surface unit 334 is capable of communicating with the drilling tools to send commands to the drilling tools, and to receive data therefrom. Surface unit 334 may also collect data generated during the drilling operation and produce data output 335, which may then be stored or transmitted.

Sensors 340, such as gauges, may be positioned about oilfield 300 to collect data relating to various oilfield operations as described previously. As shown, sensor 340 is positioned in one or more locations in the drilling tools and/or at rig 328 to measure drilling parameters, such as weight on bit, torque on bit, pressures, temperatures, flow rates, compositions, rotary speed, and/or other parameters of the field operation. Sensors 340 may also be positioned in one or more locations in the circulating system.

Drilling tools 306 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 334. The bottom hole assembly further includes drill collars for performing various other measurement functions.

The bottom hole assembly may include a communication subassembly that communicates with surface unit 334. The communication subassembly is adapted to send signals to and receive signals from the surface using a communications channel such as mud pulse telemetry, electromagnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors 340 may be collected by surface unit 334 and/or other data collection sources for analysis or other processing. The data collected by sensors 340 may be used alone or in combination with other data. The data may be collected in one or more databases and/or transmitted on or offsite. The data may be historical data, real time data, or combinations thereof. The real time data may be used in real time or stored for later use. The data may also be combined with historical data or other inputs for further analysis. The data may be stored in separate databases, or combined into a single database.

Surface unit 334 may include transceiver 337 to allow communications between surface unit 334 and various portions of the oilfield 300 or other locations. Surface unit 334 may also be provided with or functionally connected to one or more controllers (not shown) for actuating mechanisms at oilfield 300. Surface unit 334 may then send command signals to oilfield 300 in response to data received. Surface unit 334 may receive commands via transceiver 337 or may itself execute commands to the controller. A processor may be provided to analyze the data (locally or remotely), make the decisions and/or actuate the controller. In this manner, oilfield 300 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 3B illustrates a wireline operation being performed by wireline tool 306 suspended by rig 328 and into wellbore 336 of FIG. 3A. Wireline tool 342 is adapted for deployment into wellbore 336 for generating well logs, performing downhole tests and/or collecting samples. Wireline tool 342 may be used to provide another method and apparatus for performing a seismic survey operation. Wireline tool 342 may, for example, have an explosive, radioactive, electrical, or acoustic energy source 344 that sends and/or receives electrical signals to surrounding subterranean formations 302 and fluids therein.

Wireline tool 342 may be operatively connected to, for example, geophones 218 and a computer 222 of a seismic truck 206 of FIG. 2. Wireline tool 342 may also provide data to surface unit 334. Surface unit 334 may collect data generated during the wireline operation and may produce data output 335 that may be stored or transmitted. Wireline tool 342 may be positioned at various depths in the wellbore 336 to provide a survey or other information relating to the subterranean formation 302.

Sensors 340, such as gauges, may be positioned about oilfield 300 to collect data relating to various field operations as described previously. As shown in FIG. 3B, sensor 340 is positioned in wireline tool 342 to measure downhole parameters which relate to, for example porosity, permeability, fluid composition and/or other parameters of the field operation.

FIG. 3C illustrates a production operation being performed by production tool 348 deployed from a production unit or Christmas tree 329 and into completed wellbore 336 for drawing fluid from the downhole reservoirs into surface facilities 342. The fluid flows from reservoir 304 through perforations in the casing (not shown) and into production tool 348 in wellbore 336 and to surface facilities 342 via gathering network 346.

Sensors 340, such as gauges, may be positioned about oilfield 300 to collect data relating to various field operations as described previously. As shown, the sensor 340 may be positioned in production tool 348 or associated equipment, such as Christmas tree 329, gathering network 346, surface facility 342, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 3A-3C illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors 340 may be located at various positions along the wellbore and/or the monitoring tools to collect and/or monitor the desired data. Other sources of data may also be provided from offsite locations.

The field configurations of FIGS. 2 and 3A-3C are intended to provide a brief description of an example of a field usable with oilfield application frameworks. Part of, or the entiretyError! Bookmark not defined., of oilfield 200, 300 may be on land, water, and/or sea. Also, while a single field measured at a single location is depicted, oilfield applications may be utilized with any combination of one or more oilfields, one or more processing facilities and one or more wellsites.

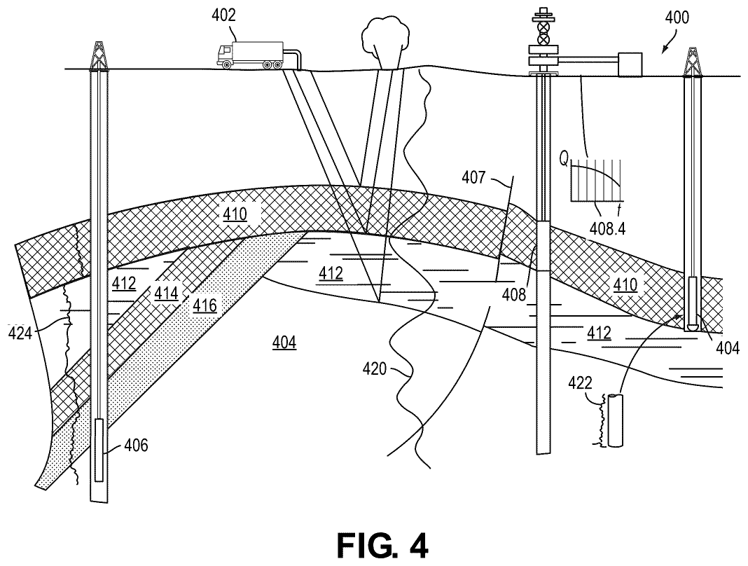

FIG. 4 illustrates a schematic view, partially in cross section of oilfield 400 having data acquisition tools 402, 404, 406 and 408 positioned at various locations along oilfield 400 for collecting data of subterranean formation 404 in accordance with implementations of various technologies and techniques described herein. Data acquisition tools 402-408 may be the same as data acquisition tools 206, 306, 342, 348 of FIGS. 2-3C, respectively, or others not depicted. As shown, data acquisition tools 402-408 generate data plots or measurements 420, 422, 424, 426, respectively. These data plots are depicted along oilfield 400 to demonstrate the data generated by the various operations.

Data plots 420-424 are examples of static data plots that may be generated by data acquisition tools 402-406, respectively; however, it should be understood that data plots 420-424 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 420 is a seismic two-way response over a period of time. Static plot 422 is core sample data measured from a core sample of the formation 404. The core sample may be used to provide data, such as a graph of the density, porosity, permeability, or some other physical property of the core sample over the length of the core. Tests for density and viscosity may be performed on the fluids in the core at varying pressures and temperatures. Static data plot 424 is a logging trace that typically [symbol] Error! Bookmark not defined. provides a resistivity or other measurement of the formation at various depths.

A production decline curve or graph 426 is a dynamic data plot of the fluid flow rate over time. The production decline curve typically [symbol] Error! Bookmark not defined. provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 404 has a plurality of geological formations 410-416. As shown, this structure has several formations or layers, including a shale layer 410, a carbonate layer 412, a shale layer 414 and a sand layer 416. A fault 407 extends through the shale layer 410 and the carbonate layer 412. The static data acquisition tools are adapted to take measurements and detect characteristics of the formations.

While a specific subterranean formation with specific geological structures is depicted, it will be appreciated that oilfield 400 may contain a variety of geological structures and/or formations, sometimes having extreme complexity. In some locations, typically [symbol] Error! Bookmark not defined. below the water line, fluid may occupy pore spaces of the formations. Each of the measurement devices may be used to measure properties of the formations and/or its geological features. While each acquisition tool is shown as being in specific locations in oilfield 400, it will be appreciated that one or more types of measurement may be taken at one or more locations across one or more fields or other locations for comparison and/or analysis.

The data collected from various sources, such as the data acquisition tools of FIG. 4, may then be processed and/or evaluated. Typically [symbol] Error! Bookmark not defined., seismic data displayed in static data plot 420 from data acquisition tool 402 is used by a geophysicist to determine characteristics of the subterranean formations and features. The core data shown in static plot 422 and/or log data from well log 424 are typically used by a geologist to determine various characteristics of the subterranean formation. The production data from graph 426 is typically used by the reservoir engineer to determine fluid flow reservoir characteristics. The data analyzed by the geologist, geophysicist and the reservoir engineer may be analyzed using modeling techniques.

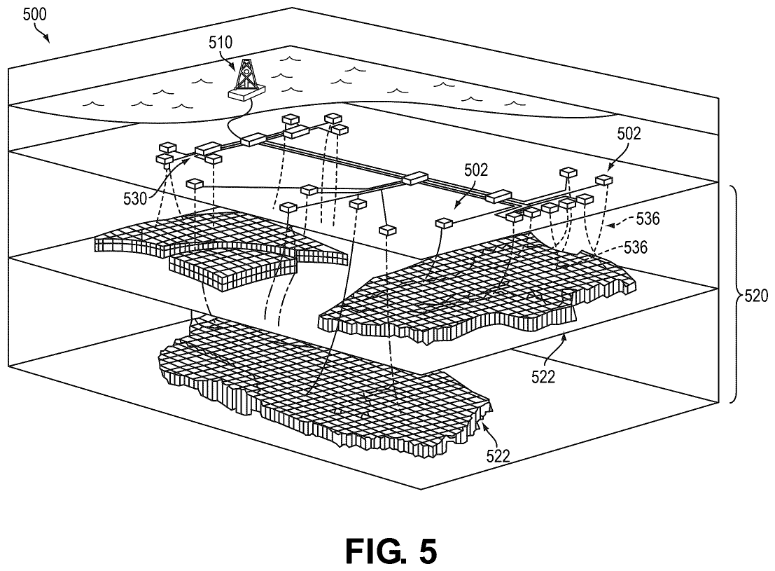

FIG. 5 illustrates an oilfield 500 for performing production operations in accordance with implementations of various technologies and techniques described herein. As shown, the oilfield has a plurality of wellsites 502 operatively connected to central processing facility 510. The oilfield configuration of FIG. 5 is not intended to limit the scope of the oilfield application system. Part, or all [symbol] Error! Bookmark not defined., of the oilfield may be on land and/or sea. Also, while a single oilfield with a single processing facility and a plurality of wellsites is depicted, any combination of one or more oilfields, one or more processing facilities and one or more wellsites may be present.

Each wellsite 502 has equipment that forms wellbore 536 into the earth. The wellbores extend through subterranean formations 520 including reservoirs 522. These reservoirs 522 contain fluids, such as hydrocarbons. The wellsites draw fluid from the reservoirs and pass them to the processing facilities via surface networks 530. The surface networks 530 have tubing and control mechanisms for controlling the flow of fluids from the wellsite to processing facility 510.

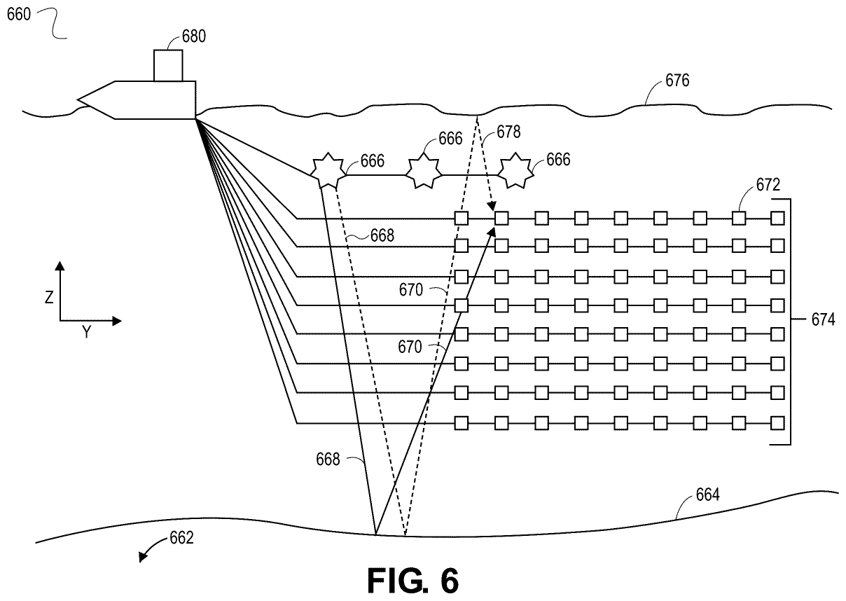

Attention is now directed to FIG. 6, which illustrates a side view of a marine-based survey 660 of a subterranean subsurface 662 in accordance with one or more implementations of various techniques described herein. Subsurface 662 includes seafloor surface 664. Seismic sources 666 may include marine sources such as vibroseis or airguns, which may propagate seismic waves 668 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 668 may be reflected and converted by seafloor surface 664 (i.e., reflector), and seismic wave reflections 670 may be received by a plurality of seismic receivers 672. Seismic receivers 672 may be disposed on a plurality of streamers (i.e., streamer array 674). The seismic receivers 672 may generate electrical signals representative of the received seismic wave reflections 670. The electrical signals may be embedded with information regarding the subsurface 662 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 670 may travel upward and reach the water/air interface at the water surface 676, a portion of reflections 670 may then reflect downward again (i.e., sea-surface ghost waves 678) and be received by the plurality of seismic receivers 672. The sea-surface ghost waves 678 may be referred to as surface multiples. The point on the water surface 676 at which the wave is reflected downward is generally referred to as the downward reflection point.

The electrical signals may be transmitted to a vessel 680 via transmission cables, wireless communication or the like. The vessel 680 may then transmit the electrical signals to a data processing center. Alternatively, the vessel 680 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 672. In one implementation, the seismic data may be processed to generate a seismic image of the subsurface 662.

Typically, marine seismic acquisition systems tow each streamer in streamer array 674 at the same depth (e.g., 5-10 m). However, marine based survey 660 may tow each streamer in streamer array 674 at different depths such that seismic data may be acquired and processed in a manner that avoids the effects of destructive interference due to sea-surface ghost waves. For instance, marine-based survey 660 of FIG. 6 illustrates eight streamers towed by vessel 680 at eight different depths. The depth of each streamer may be controlled and maintained using the birds disposed on each streamer.

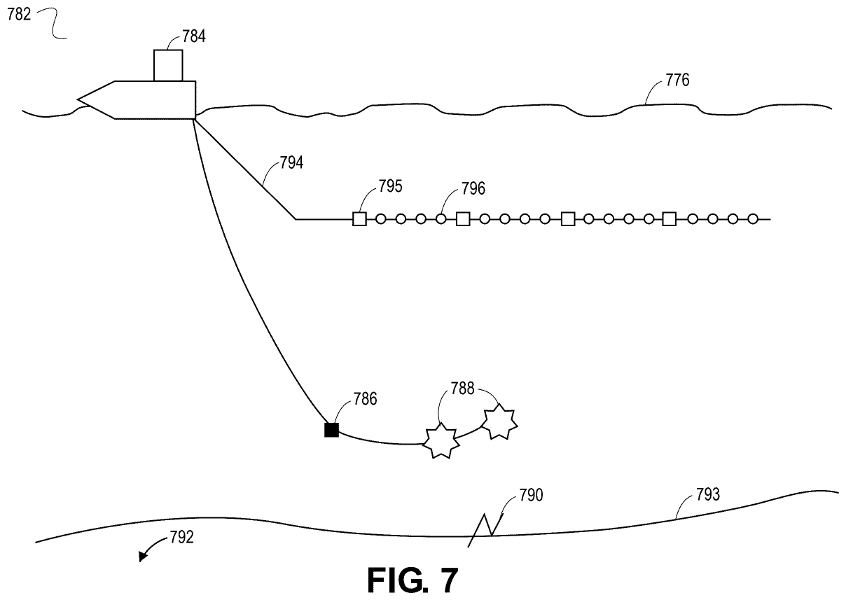

Attention is now directed to FIG. 7 that depicts a marine electromagnetic survey system 782 in accordance with implementations of various technologies described herein. The electromagnetic survey system 782 may use controlled-source electromagnetic (CSEM) survey techniques, but other electromagnetic survey techniques may also be used. Marine electromagnetic surveying may be performed by a survey vessel 784 that moves in a predetermined pattern along the surface 776 of a body of water such as a lake or the ocean. The survey vessel 784 is configured to pull a towfish (an electric source) 786, which is connected to a pair of electrodes 788. During the survey, the vessel may stop and remain stationary for a period of time while obtaining measurements, while in some circumstances, the vessel may remain underway while obtaining measurements.

At the source 786, a controlled electric current may be generated and sent through the electrodes 788 into the seawater. For instance, the electric current generated may be in the range between about 0.01 Hz and about 20 Hz. The current creates an electromagnetic field 790 in the subsurface 792 to be surveyed below the sea floor 793. The electromagnetic field 790 may also be generated by magneto-telluric currents instead of the source 786. The survey vessel 784 may also be configured to tow a sensor cable 794. The sensor cable 794 may be a marine towed cable. The sensor cable 794 may contain sensor housings 795, telemetry units 796, and current sensor electrodes (not illustrated). The sensor housings 795 may contain voltage potential electrodes for measuring the electromagnetic field 790 strength created in the subsurface area 792 during the surveying period. The current sensor electrodes may be used to measure electric field strength in directions transverse to the direction of the sensor cable 794 (the y- and z-directions). The telemetry units 795 may contain circuitry configured to determine the electric field strength using the electric current measurements made by the current sensor electrodes. While a marine-based electromagnetic survey is described in regard to FIG. 7, a land-based electromagnetic survey may also be used in accordance with implementations of various techniques described herein.

Attention is now directed to methods, techniques, and workflows for processing and/or transforming collected data that are in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept is applicable to the procedures, methods, techniques, and workflows as discussed herein. This iterative refinement can include use of feedback loops executed on an algorithmic basis, such as at a computing device (e.g., computing system 100, FIG. 1), and/or through manual control by a user who may make determinations regarding whether a given step [symbol] Error! Bookmark not defined., action, template, or model has become sufficiently accurate.

The understanding of the distribution of fractures in a subsurface may be useful or key to the description of geothermal and/or hydrocarbon reservoirs. Discrete Fracture Networks (DFN) modeling is an industry practice to characterize fractured reservoirs and integrate data from seismic, borehole images and analogs. Recent developments in DEN modeling build on physics-based geomechanical and empirical driver systems to explain observed fractures and to predict fractures in areas or regions where data may be sparse or absent. Despite a comprehensive approach that integrates multiple sources of physics-based data, conventional workflows for DEN modeling may often be time consuming and include systematic shortcomings. For example, the workflow is often manual, and modifications of DEN properties may often necessitate relatively high experience in the use of geomodelling applications, such as Petrel subsurface software (available from SLB of Houston Texas), and a deep understanding of fracture drivers' coding commands. In addition, the conventional workflows generally do not permit the analysis of many important DFN properties (e.g., the number of fractures), which may have a direct impact on predicted permeability distributions in a reservoir. Additionally, sensitivity and model calibration studies for improving model predictability have become an expensive and time-consuming exercise.

The methods and techniques disclosed or described herein facilitate multiple-realization workflows of DFNs. The DFN creation process disclosed herein is enhanced by using multiple data science tools to automate the creation of multiple synthetic versions of a physics based DFN. The methods disclosed herein provide relatively quicker and robust sensitivity analysis that extend beyond the modifiable DFN properties in the physics-based DEN creation process via modification of the properties of the synthetic versions of the physics-based DFN.

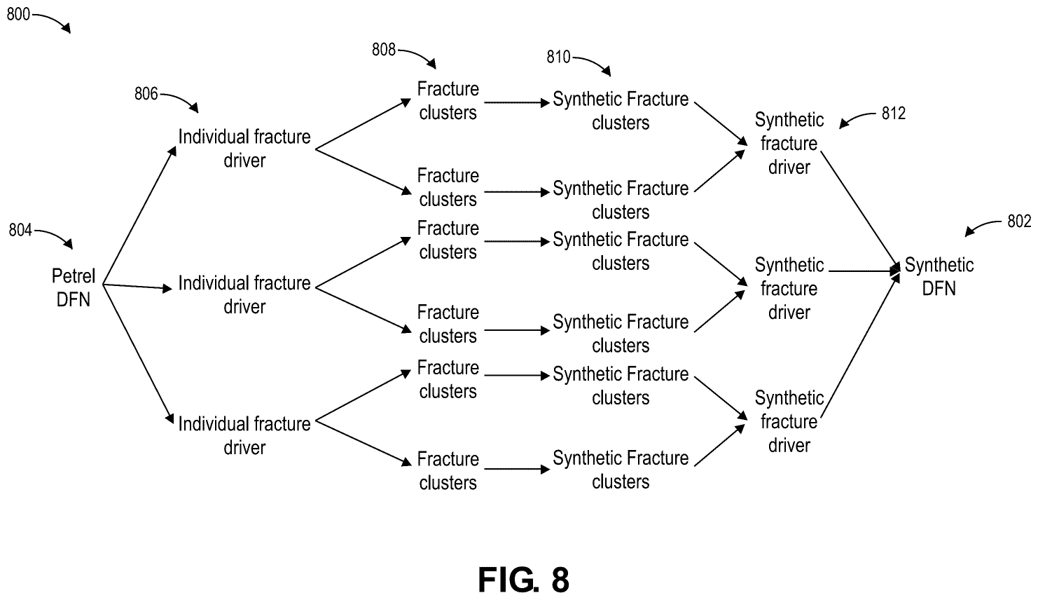

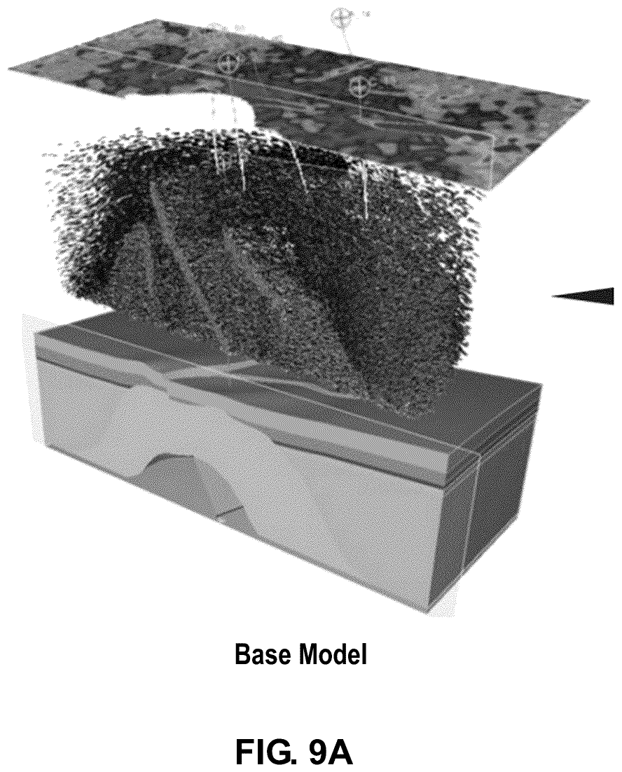

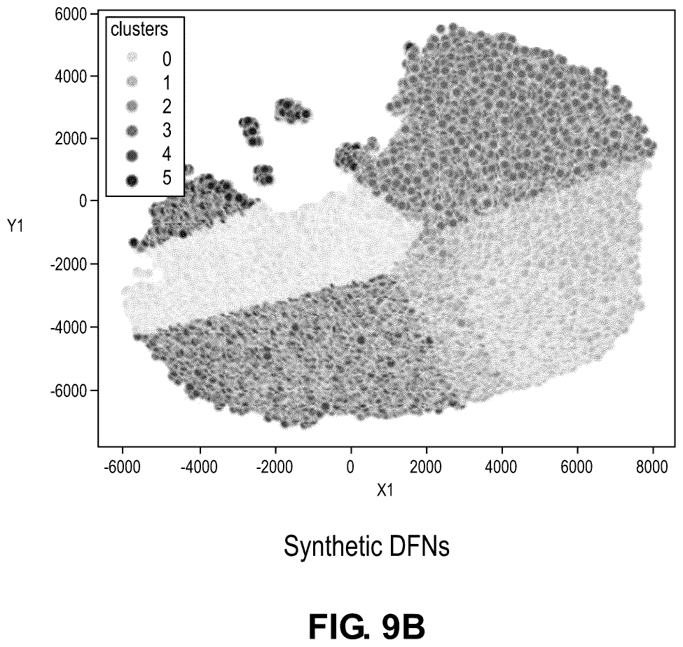

FIG. 8 illustrates an exemplary workflow 800 for generating a synthetic driver-based DFN 802, according to an embodiment. Examples of the techniques described herein include several code developments that support the following workflow 800 to create multiple synthetic DFNs. The synthetic fracture creation process, according to some examples, may be associated with or anchored to physics-based driver systems that explain fracture distribution and characteristics for different or varying geological constraints (e.g., fault systems, volcanic intrusion and thermal decay phenomena etc.). The workflow 800 supported may generally include any one or more of the following, in any order: (1) creation of a driver-based DFN, such as a full driver-based DFN, in a geomodelling tool, as at 804; (2) exporting of the driver-based DFN from the geomodelling tool to an ascii format; (3) loading DEN data to a data frame; (4) isolating one or more fractures created by each of the fracture drivers of the physics-driven DFN, as at 806; (5) applying an unsupervised machine-learning (ML) to support density-based clustering on one or more of the isolated fractures or isolated sets of fractures to provide fracture clusters, as at 808; (6) creating multi-dimensional distributions using Gaussian Mixture, to statistically model one or more properties of each of the fracture clusters; (7) generating synthetic fracture clusters with one or more statistical models, where the synthetic fracture clusters may be the same, substantially the same, or may mimic one or more statistical properties of the fracture clusters, as at 810; (8) repeating (5), (6), and/or (7) for one or more driver systems, aggregating the fracture sets, as at 812, to prepare or generate the full synthetic DFN 802; or any combination thereof. FIG. 9A illustrates an exemplary base model from Discrete Fracture Network (DFN) modeling, according to an embodiment. FIG. 9B illustrates an exemplary synthetic DFN generated from the workflow of FIG. 8, according to an embodiment. The implemented process or workflow 800 may allow individual and/or independent changes to one or more properties for any one or more of the fractures originating from one or more fracture driver systems. Illustrative on-demand changes or modifications may be or include, but are not limited to, fracture count, fracture aperture, or the like, or any combination thereof. The workflow 800 may be designed to retain a direct connection between the synthetic DFN and the physics-based driver systems. The foregoing may support predictability expectations of fracture prediction in areas where data may be sparse or absent. This may be a prerequisite to identify sweet spot regions for infill well drilling.

The methods and techniques described herein may address unmet needs including, but not limited to, automating the creation of DFNs with a pre-defined set of user parameters in the process, the ability to control the number of generated fractures for each of the fracture drivers, a connection between the DEN creation process and the data science platforms, for example Dataiku. These unmet needs may be met, for example, through the ability to define a set of parameters to change in the DFN and use it to automatically create multiple synthetic DFNs; full control over the fracture properties, and the ability to modify one or more varying or different properties for the fractures coming from different drivers; a plug-in solution to transform data between, for example, but not limited to, FAB format files and Pandas Dataframes. The examples of techniques described herein may enable facilitating the sensitivity analysis and model calibration workflows for the DEN properties in relation to permeability matching between the DFN upscaled permeability and the well-level measured permeability; and facilitating the sensitivity analysis on the fracture distribution and characteristics to match the observed fractures on the borehole level. The examples of techniques described herein may enable improvements over the current/conventional technology including, but not limited to, efficiency: examples of techniques described herein enable the automatic iteration over the fracture properties with minimal need of human intervention; flexibility: examples of techniques described herein enable breaking up driver contributions to the DFN creation process (e.g., individual regions may be modified for model calibration), which is not possible in traditional/conventional workflows; and control: examples of techniques described herein enable full control on fracture properties as part of the DFN sensitivity analysis. Some example advantages of the techniques described herein may include, but are not limited to, speed, efficiency, flexibility, control, automation, or the like, or any combination thereof.

Geological physics-based modeling may prepare the ground for predicting field performance in areas where measurement data may be sparse or absent. Data science applications may be expected to augment these workflows in terms of shortened project delivery times, simplified model validation and sensitivity assessments and preserving trust in robust prediction scenarios for reservoir management decisions. While following a holistic integrated subsurface approach and relying on solid physical foundations, subsurface uncertainties exist with a significant impact on reservoir predictions. Current tools may not provide features to carry out uncertainty analysis on the permeabilities generated by upscaling the fracture properties. As such, capturing these uncertainties may necessitate the generation of multiple Discrete Fracture Network (DFN) realizations which may be complex and time consuming. The methods and techniques disclosed herein may generate machine-learning (ML) and/or deep-learning (DL) workflows that may replicate the permeability of a base DEN using a prediction automation process, introduce uncertainty analysis workflows, and/or accelerate the decision-making by providing rapid multiple permeability estimates, and/or reducing the time and effort for scaling up fracture properties for multiple realizations.

According to some techniques a Deep Learning (DL) model may be developed or built using, for example, but not limited to, python scripts with key fracture properties (e.g., fracture intensity-P32, fracture aperture, etc.) and the geometrical control parameters of a grid (e.g., I, J, and/or K) as key features to predict permeability. Statistical examination of the input data, through box plots and other means, showed that the inputs may be featuring clear skewness and outliers. A recommended practice in dealing with such data, according to some techniques, may be using a robust scaler, a scaler technique that uses the median as central tendency and an interquartile range (IQR) as a dispersion metrics. Applying batch normalization before dropout in the DL architecture may enable the dropout layer to work on normalized activations, which may facilitate or help to prevent overfitting more effectively. For some techniques, the model may be compiled using the Adam optimizer and mean squared error (MSE) loss function. The choice of MSE may be motivated by its suitability for regression tasks, aligning well with an objective of predicting permeability values. To prevent overfitting and ensure optimal training, according to some techniques, an early stopping callback may be incorporated. This callback may monitor the validation loss and terminated training if no improvement is observed over a predefined number of epochs.

With the model for permeability prediction in place, the predictions may then be subject to an uncertainty analysis workflow. In the uncertainty analysis, a predetermined uncertainty range, such as an uncertainty range of +/−10%, on the aperture and the P32 values may be assumed. The workflow may be run to predict a predetermined number of variations, such as ten (10) variations of predictions. The number of variations of predictions may be a number of values (e.g., random values) of the aperture and/or the P32 within an assigned or predetermined range of uncertainty, according to Equations (1) and (2):

$$Ap = {Ap}^{′} \pm x \qquad ( 1 )$$

$${P}^{′} 32 = P 32 \pm x \qquad ( 2 )$$

where: x may be a random number sampled from N (0, σ), where σ may be determined as a random number between ±10% of a range for the aperture of a cell and P32 value of the cell, respectively. These 10 predictions may give a range of permeabilities considering uncertainty in the upscaled properties without modifying the base DFN. The workflow, according to some techniques, may also be designed to validate the predictions by comparing them with the permeability values from the base DFN model to identify the best prediction from the 10 variations. An exemplary workflow may be capable of or configured to run multiple variations as per user choice. To visualize the uncertainty in permeability in the area of interest, the dataset containing the variation inputs (e.g., 10 variations) and the 10 predictions may be extracted (e.g., with a Dataiku flow), and imported into a grid in a tool to visualize multiple realizations (e.g., similar to the uncertainty and optimization module within a software, such as Petrel).

Exemplary techniques described herein may address unmet needs including, but not limited to, the ability to perform uncertainty analysis on the upscaled permeability from DFN with a pre-defined set of user parameters in the process; the ability to create a user defined number of variations/realizations of permeability prediction for the uncertainty analysis; and a connection between a permeability prediction process and data science platforms, most notably Dataiku. Some examples of techniques described herein include the ability to define a set of parameters to predict permeability and the ability to define a range of uncertainty to the parameters and use it to automatically predict permeability variations/realizations. Some examples of techniques may include a connector plug-in to establish the inter-connection and smooth data transaction between a geomodelling application, such as Petrel, and a data science platform, such as Dataiku. Some example techniques may be configured to facilitate the permeability uncertainty analysis and DFN model calibration workflows for the DFN by establishing the relation between the DFN upscaled permeability and the well-level measured permeability. Some examples of improvements enabled using the techniques described herein include, but are not limited to, Time Efficiency: ML/DL-based methods may be inherently time-efficient due to their data-driven nature that streamlines the workflow by automating various aspects of permeability prediction, reducing the time and effort required; Flexibility: These techniques may enable incorporation of multiple variables with ease, enabling a more comprehensive understanding of the reservoir's behavior and characteristics; Geostatistical Simplification: ML/DL approaches, including those described herein, may minimize the need for in-depth geostatistical knowledge, making them accessible to a wider range of professionals; Quick Sensitivity Analysis: The ability to perform quick sensitivity-based data analytics may facilitate the creation of models calibrated with production data, enhancing their accuracy and reliability; Accurate and Robust Predictions: ML/DL-based models may provide accurate and robust permeability predictions due to their ability to capture complex relationships in the data; Rapid Generation of Results: Developed methods may excel the generating of results, e.g., generation of multiple realizations for capturing uncertainties efficiently.

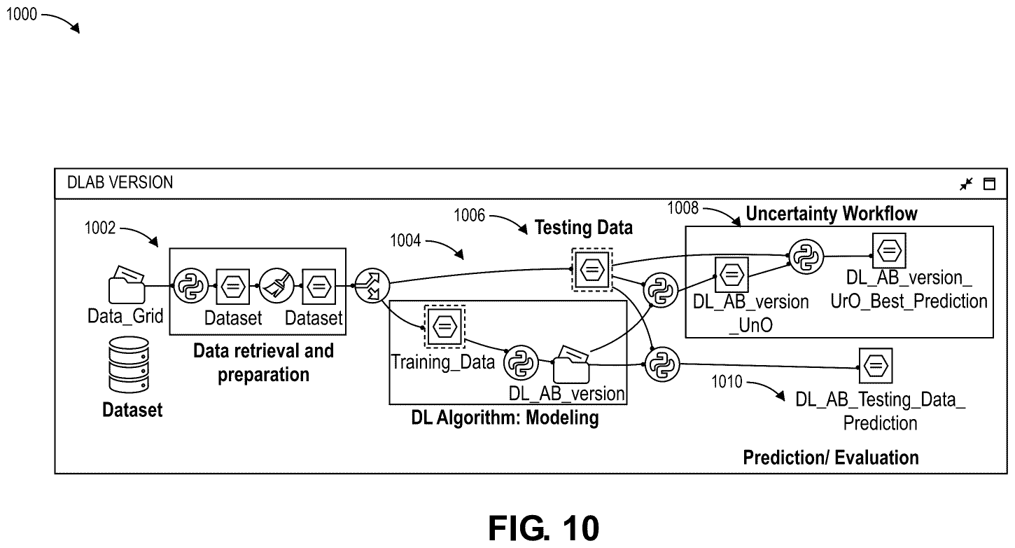

FIG. 10 illustrates an exemplary workflow 1000 including permeability prediction and uncertainty analysis, according to an embodiment. As illustrated in FIG. 10, the workflow 1000 may include data retrieval and data preparation from a dataset, as at 1002. The workflow 1000 may also include applying one or more deep-learning (DL) models to the data from the dataset, which may include training the DL model with training data, as at 1004. The workflow 1000 may also include testing the data, as at 1006. The workflow 1000 may further include an uncertainty analysis workflow, as at 1008. The workflow 1000 may also include a permeability prediction, as at 1010.

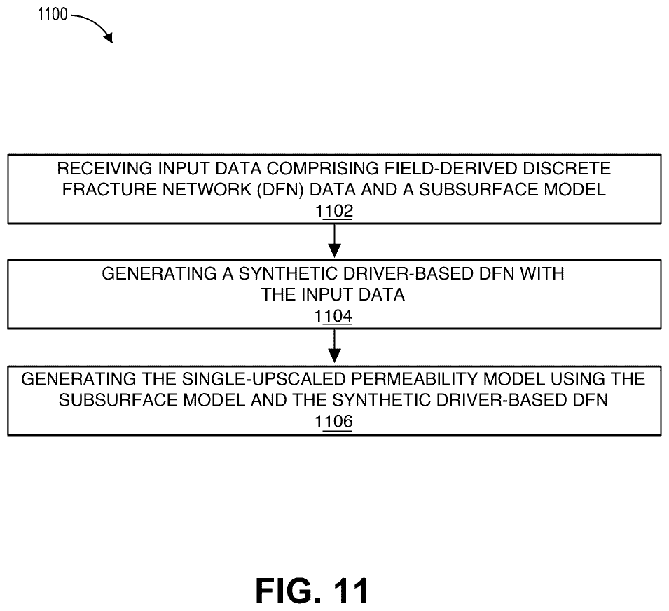

FIG. 11 illustrates a flowchart of a method 1100 for generating a single-upscaled permeability model for a subsurface, according to an embodiment. The method 1100 may include receiving input data, where the input data comprises field-derived discrete fracture network (DFN) data and a subsurface model, as at 1102. The field-derived DFN data may be derived from one or more borehole image logs, outcrop mapping, or any combination thereof. The field-derived DEN data may include a plurality of fractures. Each fracture of the plurality of fractures may be associated with a respective individual fracture driver. The subsurface model may include a multidimensional domain including a plurality of cells. The multidimensional domain may include a plurality of axes. Each axis of the plurality of axes may be defined by a respective grid interval thereof. The respective grid interval of each axis of the plurality of axes may define the plurality of cells of the multidimensional domain. The subsurface model may further include respective cell properties for each cell of the plurality of cells. The respective cell properties may include one or more of a fracture porosity, a fracture void volume, a bulk rock volume, a fracture density, an average aperture, an average fracture length, an average fracture aperture, a fracture surface area per unit volume or specific fracture area, an area of fracture, an aperture of fracture, a bulk volume of rock domain, a respective fracture porosity of the cell, a respective total fracture void volume within the cell, a linear intensity, an areal intensity, a volumetric intensity, a respective linear intensity of the cell, a respective areal intensity of the cell, a respective volumetric intensity of the cell, or any combination thereof. The subsurface model may further include fracture characterization data for each cell of the plurality of cells of the multidimensional domain. The respective fracture characterization data, for each cell of the plurality of cells, may include fracture porosity, fracture intensity, upscaled fracture permeability, or a combination thereof.

The method 1100 may also include generating a synthetic driver-based DFN with the input data, as at 1104. The synthetic driver-based DFN may be generated with the field-derived DEN data. Generating the synthetic driver-based DFN with the field-derived DEN data may include generating one or more fracture clusters with the plurality of fractures of the field-derived DFN data based on an unsupervised density-based machine-learning (ML) model. Each fracture cluster of the one or more fracture clusters may be defined by one or more statistical properties. The statistical properties of each fracture cluster may include one or more of a fracture location, a fracture dip, a fracture azimuth, a fracture length, a fracture aperture, a fracture connectivity, or any combination thereof.

Generating the synthetic driver-based DFN with the field-derived DEN data may also include generating one or more synthetic fracture clusters with the one or more fracture clusters based on an unsupervised Gaussian-based ML model. Each synthetic fracture cluster of the one or more synthetic fracture clusters may be defined by one or more synthetic statistical properties. The synthetic statistical properties of each fracture cluster may include one or more of a synthetic fracture location, a synthetic fracture dip, a synthetic fracture azimuth, a synthetic fracture length, a synthetic fracture aperture, a synthetic fracture connectivity, or any combination thereof. The respective synthetic statistical properties of the synthetic fracture clusters may be substantially the same as the respective statistical properties of the fracture clusters. Generating the synthetic driver-based DFN with the field-derived DFN data may further include generating one or more synthetic fracture drivers with the one or more synthetic fracture clusters. Generating the synthetic driver-based DFN with the field-derived DFN data may also include generating the synthetic driver-based DFN with the one or more synthetic fracture drivers.

The method 1100 may also include generating the single-upscaled permeability model using the subsurface model and the synthetic driver-based DFN, as at 1106. For example, the method 1100 may include generating the single-upscaled permeability model with the subsurface model, the field-derived discrete fracture network (DFN) data, and the synthetic driver-based DFN. Generating the single-upscaled permeability model may include upscaling the fracture characterization data for each cell of the plurality of cells of the subsurface model based on the respective cell properties to produce upscaled fracture characterization data. Upscaling the fracture characterization data for each cell of the plurality of cells of the subsurface model may include: upscaling the respective fracture porosity of each cell of the plurality of cells based on the respective cell properties to produce a respective upscaled fracture porosity; and upscaling the respective fracture intensity of each cell of the plurality of cells with/based on the respective cell properties to produce a respective upscaled fracture intensity.

Generating the single-upscaled permeability model may also include generating a fracture aperture for each cell of the plurality of cells with the upscaled fracture characterization data. The fracture aperture for each cell of the plurality of cells may be generated with the respective upscaled fracture porosity, the respective upscaled fracture intensity, or a combination thereof. Generating the single-upscaled permeability model may further include determining a fracture permeability, for each cell of the plurality of cells, with the respective fracture aperture thereof and the respective upscaled fracture porosity thereof based on a deep-learning model. Determining the fracture permeability for each cell of the plurality of cells may include determining a permeability value for each cell of the plurality of cells with the respective fracture aperture and the respective upscaled fracture porosity based on the deep-learning model. The deep-learning model may include an artificial neural network. Determining the fracture permeability for each cell of the plurality of cells may include training the deep-learning model with one or more inputs and one or more outputs. The one or more inputs may include the respective upscaled fracture characterization data for each cell of the plurality of cells. The one or more inputs may include the respective upscaled fracture intensity, the respective upscaled fracture porosity, or any combination thereof. The one or more outputs may include an upscaled fracture permeability for each cell of the plurality of cells. Training the deep-learning model may include comparing the upscaled fracture characterization data with unseen fracture characterization data. Generating the single-upscaled permeability model may also include generating the single-upscaled permeability model with the respective fracture permeability for each cell of the plurality of cells, the field-derived discrete fracture network (DFN) data, and the synthetic driver-based DFN.

The method 1100 may also include displaying the single-upscaled permeability model for the subsurface. The method 1100 may further include performing an action in response to displaying the single-upscaled permeability model for the subsurface. The action may be or include generating and/or transmitting a signal that recommends, instructs, or causes a physical action to occur. The physical action may be or include optimizing a trajectory of a wellbore drilling operation, conducting drilling operations, conducting an exploratory operation, utilizing the single-upscaled permeability model in a simulation model (e.g., reservoir simulation model) to predict one or more of fluid flow, pressure distribution, reservoir performance, or any combination thereof, designing a production strategy, designing a hydraulic fracturing strategy, conducting risk assessments, or the like, or any combination thereof.

The steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection.

Many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

Many examples of equations and mathematical expressions have been provided in this disclosure. But those with skill in the art will appreciate that variations of these expressions and equations, alternative forms of these expressions and equations, and related expressions and equations that can be derived from the example equations and expressions provided herein may also be successfully used to perform the methods, techniques, and workflows related to the embodiments disclosed herein.

While any discussion of or citation to related art in this disclosure may or may not include some prior art references, applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to explain the principles of the present disclosure and its practical applications, to thereby enable others skilled in the art to utilize the present disclosure and various embodiments with various modifications as are suited to the particular use contemplated.

Those with skill in the art will appreciate that while the quoted sections of the article above that are provided for illustrative purposes include terms that could be interpreted as potentially absolute or requiring a given thing (including without limitation “exactly”, “exact”, “only”, “key”, “important”, “requires”, “all”, “each”, “must”, “always”, etc.), the various systems, methods, processing procedures, techniques, and workflows disclosed herein are not to be understood as limited by the use of these terms

In some embodiments, the multi-dimensional region of interest includes one or more volume types selected from the group consisting of a subterranean region, human tissue, plant tissue, animal tissue, solid volumes, substantially solid volumes, volumes of liquid, volumes of gas/air, volumes of plasma, and volumes of space near and/or or outside the atmosphere of a planet, asteroid, comet, moon, or other body.

What is claimed is:

1. A method for generating a single-upscaled permeability model for a subsurface, the method comprising:
receiving input data, wherein the input data comprises field-derived discrete fracture network (DFN) data and a subsurface model;
generating a synthetic driver-based DFN based upon the field-derived DFN data; and
generating the single-upscaled permeability model using the subsurface model and the synthetic driver-based DFN.

2. The method of claim 1, wherein:
the subsurface model comprises a plurality of cells in a multidimensional domain, respective fracture characterization data for each cell of the plurality of cells, and respective cell properties for each cell of the plurality of cells; and
generating the single-upscaled permeability model comprises upscaling the respective fracture characterization data for each cell of the plurality of cells based on the respective cell properties thereof to produce upscaled fracture characterization data.

3. The method of claim 2, wherein:
the respective fracture characterization data, for each cell of the plurality of cell, comprises fracture porosity, fracture intensity, or a combination thereof; and
upscaling the fracture characterization data comprises:
upscaling the respective fracture porosity of each cell of the plurality of cells based on the respective cell properties thereof to produce a respective upscaled fracture porosity; and
upscaling the respective fracture intensity of each cell of the plurality of cells based on the respective cell properties for each cell of the plurality of cells to produce a respective upscaled fracture intensity.

4. The method of claim 2, wherein generating the single-upscaled permeability model further comprises generating a fracture aperture for each cell of the plurality of cells with the upscaled fracture characterization data.

5. The method of claim 4, wherein generating the single-upscaled permeability model further comprises determining a fracture permeability, for each cell of the plurality of cells, with the respective fracture aperture thereof and the respective upscaled fracture characterization data thereof based on a deep-learning model.

6. The method of claim 5, wherein generating the single-upscaled permeability model further comprises generating the single-upscaled permeability model based on the respective fracture permeability for each cell of the plurality of cells, the field-derived DFN data, and the synthetic driver-based DFN.

7. The method of claim 6, further comprising conducting an uncertainty analysis workflow, for each cell of the plurality of cells, based on the respective fracture aperture thereof and the respective upscaled fracture characterization data thereof.

8. The method of claim 7, wherein conducting the uncertainty analysis workflow comprises
applying a scaling operation, for each cell of the plurality of cells, to the respective fracture aperture thereof and the respective upscaled fracture characterization data to produce a scaled fracture aperture and a scaled fracture characterization data, respectively;
determining, for each cell of the plurality of cells, a scaled fracture permeability based on the scaled fracture aperture thereof and the scaled fracture characterization data thereof; and
comparing, for each cell of the plurality of cells, the scaled fracture permeability based on the input data.

9. The method of claim 1, further comprising displaying the single-upscaled permeability model for the subsurface.

10. The method of claim 9, further comprising performing an action in response to displaying the single-upscaled permeability model, wherein the action comprises generating and/or transmitting a signal that recommends, instructs, or causes a physical action to occur, and wherein the physical action comprises one or more of optimizing a trajectory of a wellbore drilling operation, conducting drilling operations, conducting an exploratory operation, utilizing the single-upscaled permeability model in a simulation model, designing a production strategy, designing a hydraulic fracturing strategy, conducting risk assessments, or any combination thereof.

11. A computing system, comprising:
one or more processors; and
a memory system comprising one or more non-transitory computer-readable media storing instructions that, when executed by at least one of the one or more processors, cause the computing system to perform operations, the operations comprising:
receiving input data, wherein the input data comprises field-derived discrete fracture network (DFN) data, a subsurface model, or any combination thereof, wherein the subsurface model comprises a multidimensional domain comprising a plurality of cells, and wherein the subsurface model further comprises, for each cell of the plurality of cells, fracture characterization data;
generating a synthetic driver-based DFN based upon the field-derived DEN data;
generating a single-upscaled permeability model based upon the subsurface model, the field-derived DEN data, and the synthetic driver-based DFN, wherein generating the single-upscaled permeability model comprises:
upscaling the respective fracture characterization data for each cell of the plurality of cells based upon the subsurface model to produce upscaled fracture characterization data;
generating a fracture aperture for each cell of the plurality of cells based upon the upscaled fracture characterization data;
determining a fracture permeability, for each cell of the plurality of cells, using the respective fracture aperture thereof and the respective upscaled fracture characterization data thereof based upon a deep-learning model; and
generating the single-upscaled permeability model based upon the respective fracture permeability for each cell of the plurality of cells, the field-derived DFN data, and the synthetic driver-based DFN.

12. The computing system of claim 11, wherein:
the field-derived DEN data comprises a plurality of fractures; and
generating the synthetic driver-based DFN comprises:
generating one or more fracture clusters using the plurality of fractures of the field-derived DEN data based upon an unsupervised density-based machine-learning (ML) model;
generating one or more synthetic fracture clusters using the one or more fracture clusters based upon an unsupervised Gaussian-based ML model;
generating one or more synthetic fracture drivers based upon the one or more synthetic fracture clusters; and
generating the synthetic driver-based DFN based upon the one or more synthetic fracture drivers.

13. The computing system of claim 11, wherein the subsurface model further comprises respective cell properties for each cell of the plurality of cells, and wherein the upscaled fracture characterization data for each cell of the plurality of cells is based upon the respective cell properties thereof.

14. The computing system of claim 11, further comprising conducting an uncertainty analysis workflow, for each cell of the plurality of cells, based upon the respective fracture aperture thereof and the upscaled fracture characterization data thereof.

15. The computing system of claim 14, wherein conducting the uncertainty analysis workflow comprises:
applying a scaling operation, for each cell of the plurality of cells, to the respective fracture aperture thereof and the respective upscaled fracture characterization data thereof to produce a scaled fracture aperture and a scaled fracture characterization data, respectively;
determining, for each cell of the plurality of cells, a scaled fracture permeability based upon the scaled fracture aperture thereof and the scaled fracture characterization data thereof; and
comparing, for each cell of the plurality of cells, the scaled fracture permeability with the fracture permeability.

16. A non-transitory computer-readable medium storing instructions that, when executed by one or more processors of a computing system, cause the computing system to perform operations, the operations comprising:
receiving input data, wherein the input data comprises field-derived discrete fracture network (DFN) data, a subsurface model, or any combination thereof, wherein the field-derived DEN data comprises a plurality of fractures, wherein the subsurface model comprises a multidimensional domain comprising a plurality of cells, and wherein the subsurface model further comprises, for each cell of the plurality of cells, fracture characterization data and cell properties;
generating a synthetic driver-based DFN based upon the field-derived DFN data, wherein generating the synthetic driver-based DFN comprises:
generating one or more fracture clusters using the plurality of fractures based upon an unsupervised density-based machine-learning (ML) model;
generating one or more synthetic fracture clusters using the one or more fracture clusters based upon an unsupervised Gaussian-based ML model;
generating one or more synthetic fracture drivers using the one or more synthetic fracture clusters; and
generating the synthetic driver-based DFN based upon the one or more synthetic fracture drivers;
generating a single-upscaled permeability model based upon the subsurface model, the field-derived DFN data, and the synthetic driver-based DFN, wherein generating the single-upscaled permeability model comprises:
upscaling the respective fracture characterization data for each cell of the plurality of cells of the subsurface model based upon the respective cell properties thereof to produce upscaled fracture characterization data;
generating a fracture aperture for each cell of the plurality of cells based upon the upscaled fracture characterization data;
determining a fracture permeability, for each cell of the plurality of cells, using the respective fracture aperture thereof and the respective upscaled fracture characterization data thereof based upon a deep-learning model; and
generating the single-upscaled permeability model based upon the respective fracture permeability for each cell of the plurality of cells, the field-derived DFN data, and the synthetic driver-based DFN.

17. The non-transitory computer-readable medium of claim 16, wherein:
each fracture cluster of the one or more fracture clusters is defined by one or more statistical properties, and wherein the one or more statistical properties comprise one or more of a fracture location, a fracture dip, a fracture azimuth, a fracture length, a fracture aperture, a fracture connectivity, or any combination thereof;
each synthetic fracture cluster of the one or more synthetic fracture clusters is defined by one or more synthetic statistical properties, wherein the one or more synthetic statistical properties comprise one or more of a synthetic fracture location, a synthetic fracture dip, a synthetic fracture azimuth, a synthetic fracture length, a synthetic fracture aperture, a synthetic fracture connectivity, or any combination thereof; and
the one or more synthetic statistical properties of the one or more synthetic fracture clusters are substantially the same as the one or more statistical properties of the one or more fracture clusters.

18. The non-transitory computer-readable medium of claim 16, wherein:
the respective fracture characterization data, for each cell of the plurality of cell, comprises fracture porosity, fracture intensity, or a combination thereof; and
upscaling the fracture characterization data for each cell of the plurality of cells comprises:
upscaling the respective fracture porosity of each cell of the plurality of cells based upon the respective cell properties thereof to produce a respective upscaled fracture porosity; and
upscaling the respective fracture intensity of each cell of the plurality of cells based upon the respective cell properties thereof to produce a respective upscaled fracture intensity; and
the respective fracture aperture for each cell of the plurality of cells is generated based upon the respective upscaled fracture porosity and the respective upscaled fracture intensity.

19. The non-transitory computer-readable medium of claim 18, wherein determining the fracture permeability for each cell of the plurality of cells comprises determining a permeability value for each cell of the plurality of cells with the respective fracture aperture thereof and the respective upscaled fracture porosity thereof based upon the deep-learning model.

20. The non-transitory computer-readable medium of claim 18, further comprising conducting an uncertainty analysis workflow, for each cell of the plurality of cells, with the respective fracture aperture thereof and the respective upscaled fracture porosity thereof, wherein conducting the uncertainty analysis workflow comprises:
applying a mathematical scaling operation, for each cell of the plurality of cells, to the respective fracture aperture thereof and the respective upscaled fracture porosity thereof to produce a scaled fracture aperture and a scaled fracture porosity, respectively;
determining, for each cell of the plurality of cells, a scaled fracture permeability based upon the scaled fracture aperture thereof and the scaled fracture porosity thereof; and
comparing, for each cell of the plurality of cells, the scaled fracture permeability with the fracture permeability.
